(19) United States
(12) Patent Application Publication
(10) Pub. No.: US 2009/0276613 A1
(43) Pub. Date: Nov. 5, 2009

(54) METHOD OF SHARING BASIC INPUT OUTPUT SYSTEM, AND BLADE SERVER AND COMPUTER USING THE SAME

(75) Inventors: KUO-WEI HUANG, Taipei City (TW); Chin-Hung Lu, Taipei City (TW)

Correspondence Address: J C PATENTS, 4 VENTURE, SUITE 250, IRVINE, CA, 92618, US

(73) Assignee: Inventec Corporation, Taipei City (TW)

(21) Appl. No.: 12/140,083

(22) Filed: Jun. 16, 2008

(30) Foreign Application Priority Data
May 2, 2008 (TW) 97116193

(51) Int. Cl. G06F 15/177

(52) U.S. Cl. 713/2

(57) ABSTRACT

A blade server is provided. The blade server includes at least one motherboard, and a backplane. The backplane is coupled to the at least one motherboard, and includes a memory unit and a switch unit. The memory unit is adapted for storing a BIOS. The switch unit is coupled between the motherboard and the memory unit, for coupling the memory unit to one of the at least one motherboard. The present invention is adapted for using less memory units when configuring a blade server.

### CROSS-REFERENCE TO RELATED APPLICATION

This application claims the priority benefit of Taiwan application serial no. 97116193, filed on May 2, 2008. The entirety of the above-mentioned patent application is hereby incorporated by reference herein and made a part of this specification.

### BACKGROUND OF THE INVENTION

1. Field of the Invention

The present invention generally relates to servers and computers, and more particularly, to a method for sharing a basic input output system (BIOS), and a blade server and a computer using the same.

2. Description of Related Art

A blade server is a typically defined as integrating hardware of server system such as processor, memory, or even hard drive to a single motherboard, which share in common sources such as chassis, power supply, keyboard, display or mouse. Therefore, many such blade servers can be loaded in a single chassis so as to satisfy the demand of conventional rack mount server for saving space. Accordingly, because of having the foregoing advantages, there are many manufacturers involved in development of the blade servers.

However, the currently used blade servers, just like those conventional electronic computers, equip a BIOS in each motherboard. In a blade server, all motherboards are operated in a general chassis system. As such, when every motherboard is required to refresh a powering up program of the BIOS, each motherboard has to turn on its power, and a refreshing program has to be executed regarding each motherboard. Apparently, doing this would waste time, and is inefficient. Furthermore, every motherboard has to be equipped with a read-only memory (ROM) for storing the BIOS, and therefore such a blade server employs too much electronic component and is unthrifty.

### SUMMARY OF THE INVENTION

Accordingly, the present invention is directed to a method of sharing a BIOS, and a blade server and a computer for using the same, so as to save the components employed therein, and improve the efficiency of refreshing the BIOS. Further, the present invention is also directed to avoid a failure of the blade server and the computer being incapable of powering up because of there is only one BIOS while the BIOS runs abnormally.

The present invention provides a blade server, including at least one motherboard, and a backplane. The backplane is coupled to the at least one motherboard, and includes a memory unit and a switch unit. The memory unit is adapted for storing a BIOS. The switch unit is coupled between the at least one motherboard and the memory unit, for coupling the memory unit to one of the at least one motherboard.

According to an embodiment of the present invention, the backplane further includes a second memory unit. The second memory unit is coupled to the switch unit for storing a second BIOS. When the memory unit runs abnormally, the switch unit couples the second memory unit to one of the at least one motherboard. According to another embodiment of the present invention, the second memory unit is a non-volatile memory.

According to an embodiment of the present invention, the backplane further includes a control unit. The control unit is coupled to the switch unit for generating a control signal according to whether there is a power up signal generated by the at least one motherboard, and a busy status of the memory unit or a busy status of the second memory unit, so as to select one of the at least one motherboard to access the memory unit or the second memory unit via the switch unit.

According to an embodiment of the present invention, each of the at least one motherboard includes a central processing unit (CPU), a north bridge chip, a south bridge chip, and a switch. The north bridge chip is coupled to the CPU. The south bridge chip is coupled to the north bridge chip, and includes a general purpose input/output (GPIO) port, a power management unit, and an access controller. The GPIO port is provided for generating a reset signal. The power management unit is adapted to determine whether to execute a power up operation according to a power starting instruction signal. The access controller is coupled to the switch unit for accessing the memory unit or the second memory unit. The switch is provided for generating the power up signal according to a conduction status thereof.

According to an embodiment of the present invention, the control unit includes a register, at least one logic unit and a selector. The register is adapted for recording a busy status of the memory unit or a busy status of the second memory unit. The busy status of the memory unit or the busy status of the second memory unit varies according to the reset signal and the power starting instruction signal for indicating whether there is one of the at least one motherboard presently accessing the memory unit or the second memory unit.

Each of the at least one logic unit determines whether to generate a power starting instruction signal according to the power up signal and the busy status of the memory unit or the power up signal and the busy status of the second memory unit. The selector is adapted for generating the control signal according to the power starting instruction signal so as to control the switch unit to switch the memory unit or the second memory unit to a corresponding one of the at least one motherboard. According to another embodiment of the present invention, each of the at least one logic unit includes an AND gate having a first input terminal, a second terminal, and an output terminal. The first input terminal of the AND gate is adapted to receive the power up signal. The second terminal of the AND gate is adapted to receive the busy status of the memory unit or the busy status of the second memory unit. The AND gate generates the power starting instruction signal at the output terminal. According to a further embodiment of the present invention, the memory unit is a non-volatile memory.

The present invention further provides an operation method of a blade server. The blade server includes at least one motherboard coupling to a memory unit or a second memory unit via a switch unit. The method includes the steps of: providing a control signal; and selecting to couple the memory unit or the second memory unit to one of the at least one motherboard via the switch unit according to the control signal, so as to allow the one of the at least one motherboard to access a BIOS of the memory unit or a second BIOS of the second memory unit to execute a power up program of the BIOS of the memory unit or the second BIOS of the second memory unit.

According to an embodiment of the present invention, the step of providing the control signal includes: providing a power up signal for determining whether to generate the power starting instruction signal according to the power up signal and the busy status of the memory unit, or the power up signal and the busy status of the second memory unit, and adjusting the busy status of the memory unit or the busy status of the second memory unit according to the power starting instruction signal to indicate the one of the at least one motherboard accessing the memory unit or the second memory unit, and generating the control signal.

According to an embodiment of the present invention, the method further includes a step of generating a reset signal for adjusting the busy status of the memory unit or the busy status of the second memory unit, and indicating that there is no motherboard accessing the memory unit or the second memory unit.

The present invention further provides a computer, including a plurality of central processing units (CPUs), a plurality of chipsets, a memory unit, and a switch unit. Each of the chipsets is coupled to one of the CPUs. The memory unit is adapted for storing a BIOS. The switch unit is coupled between the chipsets and the memory unit, for selecting one of the chipsets according to a control signal, and providing an electric path to allow the selected chipset to access the BIOS of the memory unit.

According to an embodiment of the present invention, the computer further includes a second memory unit. The second memory unit is coupled to the switch unit, for storing a second BIOS, in which when the memory unit runs abnormally, the switch unit selects one of the chipsets according to the control signal, and provides a second electric path to allow the selected chipset to access the second BIOS of the second memory unit. According to another embodiment of the present invention, the second memory is a non-volatile memory.

According to an embodiment of the present invention, the computer further includes a control unit. The control unit is coupled to the switch unit for generating the control signal according to a power up signal and a busy status of the memory unit or a busy status of the second memory unit.

According to an embodiment of the present invention, the control unit includes a register, a plurality of logic units and a selector. The register is adapted for recording a busy status of the memory unit or a busy status of the second memory unit. The busy status of the memory unit or the busy status of the second memory unit varies according to a reset signal and a power starting instruction signal, for indicating whether there is one of the chipsets presently accessing the memory unit or the second memory unit. Each of the at least one logic unit correspondingly generate a power starting instruction signal according to the power up signal and the busy status of the memory unit or the power up signal and the busy status of the second memory unit. The selector is adapted to generate the control signal according to the power starting instruction signal for controlling the switch unit to switch the memory unit or the second memory unit to a corresponding one of the chipsets.

According to an embodiment of the present invention, each logic unit includes an AND gate. The AND gate has a first input terminal, a second terminal, and an output terminal. The first input terminal of the AND gate is adapted to receive the power up signal. The second terminal of the AND gate is adapted to receive the busy status of the memory unit or the busy status of the second memory unit. The AND gate generates the power starting instruction signal at the output terminal.

According to an embodiment of the present invention, each chipset includes a GPIO port, a power management unit, and an access controller. The GPIO port is provided for generating a reset signal. The power management unit is adapted for determining whether to start the chipset according to the power starting instruction signal. The access controller is coupled to the switch unit for accessing the memory unit or the second memory unit. According to another embodiment of the present invention, the memory unit is a non-volatile memory.

The present invention allows the motherboards or CPUs or chipsets to share a BIOS of a memory unit by switching. In such a way, the present invention is adapted for not only saving circuit cost, but also improving the refreshing efficiency of the BIOS. Further, the present invention equips with a second memory unit in addition to the memory unit, and stores a second BIOS in the second memory unit, so that when the memory unit runs abnormally, the motherboards, the CPUs, or the chipsets can execute the power up operation with the second memory unit.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram illustrating a blade server according to an embodiment of the present invention.

FIG. 2 illustrates an embodiment of the blade server of the FIG. 1.

FIG. 3 illustrates the embodiment of the blade server of FIG. 2 in details.

FIG. 4 is a flow chart illustrating a method for operating a blade server according to an embodiment of the present invention.

FIG. 5 is a flow chart illustrating a method for operating a blade server according to another embodiment of the present invention.

FIG. 6 is a block diagram illustrating a computer according to an embodiment of the present invention.

FIG. 7 illustrates an embodiment of the computer of FIG. 6.

FIG. 8 illustrates the computer of FIG. 7 in details.

### DESCRIPTION OF THE EMBODIMENTS

Reference will now be made in detail to the present preferred embodiments of the invention, examples of which are illustrated in the accompanying drawings. Wherever possible, the same reference counting numbers are used in the drawings and the description to refer to the same or like parts.

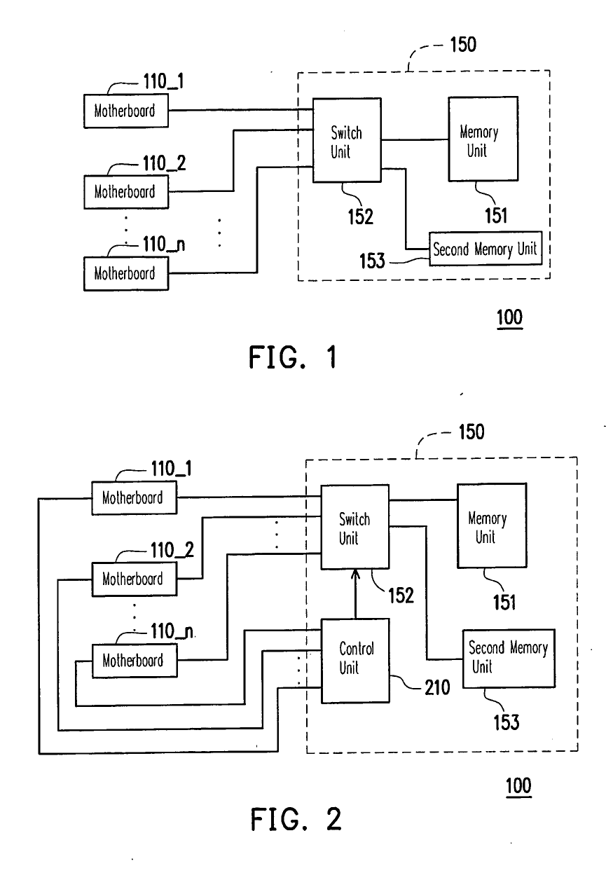

FIG. 1 is a block diagram illustrating a blade server according to an embodiment of the present invention. Referring to FIG. 1, it illustrates a blade server 100 including motherboards 110_1 through 110_{—}n, and a backplane 150, wherein n is a positive integer greater than 0, while the range is not restricted hereby. The backplane 150 is coupled to the motherboards 110_1 through 110_{—}n. The backplane 150 includes a memory unit 151, and a switch unit 152. The memory unit 151 is adapted for storing a basic input output system (BIOS). In the current embodiment, the memory unit 151 is preferably a non-volatile memory.

The switch unit 152 is coupled between the motherboards 110_1 through 110_{—}n, and the memory unit 151, for allowing the memory unit 151 to be coupled to one of the motherboards 110_1 through 110_{—}n. The blade server 100 further includes a bus coupled between the motherboards 110_1 through 110_{—}n and the memory unit 151. In the current embodiment, the bus is preferably, but not restricted to be a serial peripheral interface (SPI) bus.

In general, when a power of one of the motherboards 110_1 through 110_{—}n is turned on, the switch unit 152 correspondingly switch the memory unit 151 to the one of the motherboards 110_1 through 110_{—}n, so as to allow the one of the motherboards 110_1 through 110_{—}n to access the memory unit 151, and execute a power up program of the BIOS.

In such a way, the motherboards 110_1 through 110_{—}n is adapted to share the BIOS of the memory unit 151, so as for using less memory units 151 than conventional, and saving production cost thereof. Further, when refreshing the power up program of the BIOS, it is only required to be executed to the memory unit 151, thus the refreshing time can be saved, and the refreshing efficiency can be improved.

In the current embodiment, the backplane 150 further includes a second memory 153, which is for example a non-volatile memory. The second memory unit 153 is coupled to the switch unit 152 for storing a second BISO (a back up BIOS). Therefore, when the memory unit 151 runs abnormally, the switch unit 152 will correspondingly switch the second memory unit 153 to one of the motherboards 110_1 through 110_{—}n, after the power of the motherboards 110_1 through 110_{—}n is turned on, so as to allow the one of the motherboards 110_1 through 110_{—}n to access the second memory unit 153, and execute the power up program of the second BIOS. In such a way, it can be prevented that when there is only the memory unit 151, while the memory unit 151 runs abnormally, the motherboards 110_1 through 110_{—}n can not execute the power up program.

FIG. 2 illustrates an embodiment of the blade server 100 of FIG. 1. Referring to FIG. 2, the backplane 150 further includes a control unit 210. The control unit 210 is coupled to and control the switch unit 152 for outputting a control signal to select one of the motherboards 110_1 through 110_{—}n to access the memory unit 151 or the second memory unit 153 via the switch unit 152 according to the whether there is a power up signal generated by the motherboards 110_1 through 110_{—}n, and a busy status of the memory unit 151, or whether there is a power up signal generated by the motherboards 110_1 through 110_{—}n, and a busy status of the second memory unit 151.

For example, if the motherboard 110_1 generates a power up signal, and the busy status of the memory unit 151 is idle (not busy), the control unit 210 then outputs a control signal, e.g., logic 1, to select the motherboard 110_1 to access the memory 151 via the switch unit 152, so that the motherboard 110_1 is allowed to execute the power up program of the BIOS of the memory unit 151.

If the motherboard 110_1 generates a power up signal, and the busy status of the memory unit 151 is busy, then the control unit 210 outputs a control signal, e.g., logic 0, indicating that there is a motherboard other than 110_1 presently accessing the memory unit 151, and in this case, the motherboard 110_1 is not allowed to execute the power up program.

Further, in case the memory unit 151 runs abnormally, the switch unit 152 will control to execute the power up program of the motherboards 110_1 through 110_{—}n by the second memory unit 153. The operation of the second memory unit 153 is similar as discussed about the memory unit 151 and is not to be iterated hereby.

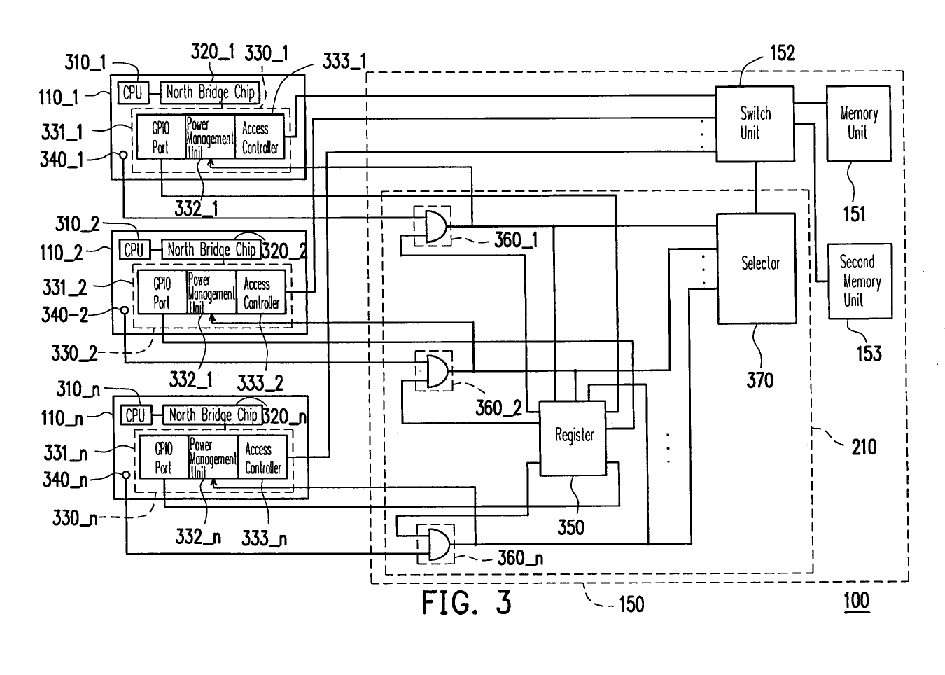

FIG. 3 illustrates the embodiment of the blade server of FIG. 2 in details. In the current embodiment, for convenience of illustration, the motherboard 110_1 is taken as an example for illustrating the inside structure of the motherboards 110_1 through 110_{—}n. Referring to FIG. 3, the motherboard 110_1 includes a central processing unit (CPU) 310_1, a north chip 320_1, a south chip 330_1, and a switch 340_1. The north chip 320_1 is coupled to the CPU 310_1. The south chip 330_1 is coupled to the north chip 320_1. The south chip 330_1 includes a general purpose input output (GPIO) port 331_1, a power management unit 332_1, and an access controller 333_1. The GPIO port 331_1 is adapted for generating a reset signal. The power management unit 332_1 is adapted for determining whether the motherboard 110_1 executes the power up operation according to a power starting instruction signal. The access controller 333_1 is coupled to the switch unit 152 for accessing the memory unit 151. The switch 340_1 is adapted for enabling the power up signal according to a conduction status thereof.

The control unit 210 includes a register 350, a logic unit 360_1 through 360_{—}n, and a selector 370. The register 350 is adapted for storing the busy status of the memory unit 151. The busy status of the memory unit 151 varies according to the reset signal and the power starting instruction signal, to indicate whether there is one of the motherboards 110_1 through 110_{—}n accessing the memory unit 151. For example, when the busy status of the memory unit 151 indicates a logic 1, it indicates that none of the motherboards 110_1 through 110_{—}n is accessing the memory unit 151, i.e., the memory unit 151 is idle (not busy). On the contrary, if the busy status of the memory unit 151 indicates a logic 0, it indicates that there is one of the motherboards 110_1 through 110_{—}n is accessing the memory unit 151, i.e., the memory unit 151 is busy. Further, the reset signal for example is capable of convert the busy status of the memory unit 151 from logic 0 to logic 1, while the power starting instruction signal for example is capable of convert the busy status of the memory unit 151 from logic 1 to logic 0.

The logic units 360_1 through 360_{—}n determines whether to generate the power starting instruction signal according to the power up signal and the busy status of the memory unit 151. In the current embodiment, each of the logic units 360_1 through 360_{—}n includes an AND gate. The AND gate has a first input terminal for receiving the power up signal, a second terminal for receiving the busy status of the memory unit 151, and an output terminal at which the power starting instruction signal is generated. The selector 370 is adapted for generating the control signal according to the power starting instruction signal, so as to control the switch unit 152 to switch the memory unit 151 to the corresponding one of the motherboards 110_1 through 110_{—}n.

The operation of the blade server 100 according to the embodiment of the present invention will be discussed herebelow in more details. First, suppose a user presses a button 340_1 of the motherboard 110_1, this enables a power up signal, e.g., a logic 1, and the power up signal is transmitted to the logic unit 360_1, while on the other hand, supposing that the busy status of the memory unit 151 stored in the register 350 is indicated to be a logic 1, then this represents that there is no motherboard presently accessing the memory unit 151. As such, every signal received by the logic unit 360_1 is logic 1, then the logic unit 360_1 generates a power starting instruction signal of logic 1, and transmits the same respectively to the power management unit 332_1, the register 350, and the selector 370 of the motherboard 110_1.

When the power management unit 332_1 receives the power starting instruction signal, logic 1, it determines to allow the motherboard 110_1 to execute the power up operation. Further, when the power starting instruction signal, logic 1, is transmitted to the register 350, it converts the busy status of the memory unit 151 stored in the register 350 from logic 1 to logic 0, indicating that the motherboard 110_1 is accessing the memory unit 151.

Further, when the power starting instruction signal, logic 1 is transmitted to the selector 370, the selector 370 generates a control signal to switch the memory unit 151 to the motherboard 110_1 according to the power starting instruction signal. When the switch 152 receives the control signal, it couples the memory unit 151 to the access controller 333_1 of the motherboard 110_1 so as to access the memory unit 151, and execute the power up program of the BIOS.

Finally, after power up operation of the motherboard 110_1 is completed, the motherboard 110_1 generates a reset signal by the GPIO port 331_1 and transmits the same to the register 350 to convert the busy status of the memory unit 151 stored in the register 350 from logic 0 to logic 1 indicating that there is no motherboard presently accessing the memory unit 151. Further, the power up operation of any other motherboards 110_2 through 110_{—}n can be learnt by referring to the foregoing description, and is not to be iterated hereby.

Further, in the current embodiment, when executing the power up operation, the motherboard 110_1 has changed the busy status of the memory unit 151 stored in the register 350 from logic 1 to logic 0, and when receiving that the busy status of the memory unit 151 of logic 0, the logic units 360_2 through 360_{—}n cannot generate a power starting instruction signal of logic 1. And therefore, the motherboards 110_2 through 110_{—}n are incapable of executing any power up operation before the completion of the power up operation of the motherboard 110_1.

The foregoing is exemplified with a normally operated memory unit 151. However, the memory unit 151 may occasionally run abnormally. When the memory unit 151 runs abnormally, the control unit 210 will control the switch unit 152 to switch the second memory unit 153 to the corresponding one of the motherboards 110_1 through 110_{—}n, so as to allow the one of the motherboards 110_1 through 110_{—}n which is coupled to the second memory unit 153 to execute the power up operation with the second BIOS. The method of executing the power up operation with the second memory unit 153 can be learnt by referring to the description with respect to the memory unit 151, and is not to be iterated hereby.

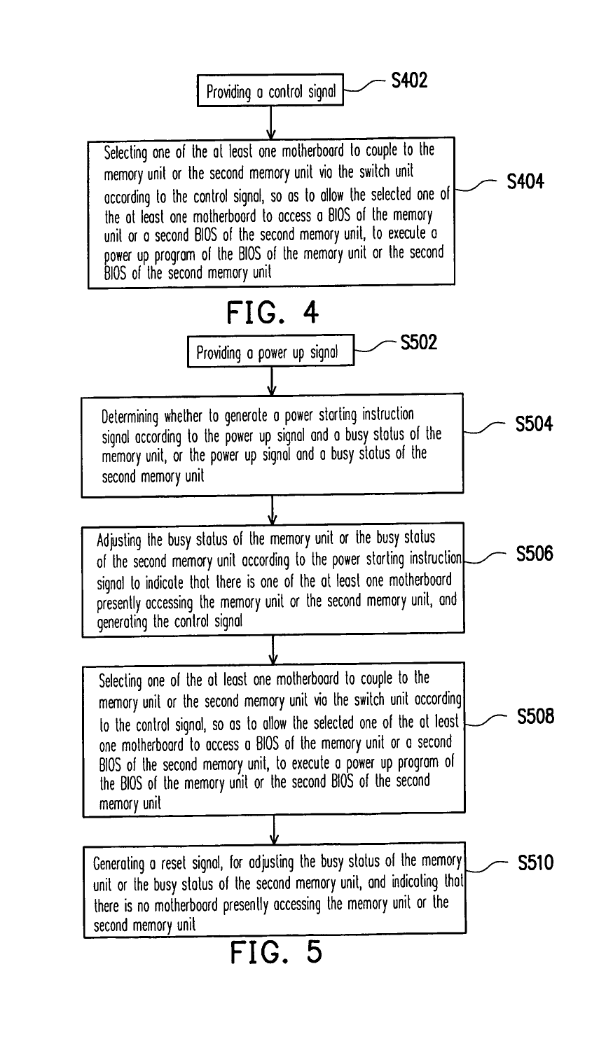

According to the foregoing embodiment, an operation method of the blade server can be obtained. FIG. 4 is a flow chart illustrating a method for operating a blade server according to an embodiment of the present invention. Referring to FIG. 4, at step S402, a control signal is provided. Then at step S404, the memory unit or the second memory unit is correspondingly coupled to one of the at least one motherboard according to the control signal, so as to allow one of the at least one motherboard to access the memory unit or the second memory unit, to execute a power up program of the BIOS of the memory unit or the second BIOS of the second memory unit. For example, the control unit is adapted to indicate to which one of the motherboards the memory unit should be switched. Taking FIG. 1 as an example, the control signal indicates that the memory unit 151 should be switched to the motherboard 110_2, and when the memory unit 151 is switched to the motherboard 110_2, the motherboard 110_2 is allowed to access the memory unit 151, to execute the power up program of the BIOS. Further, when the memory unit runs abnormally, the control signal is also adapted for indicating to which one of the motherboards the second memory unit should be switched. Also taking FIG. 1 as an example, when the control signal indicates that the second memory unit 153 should be switched to the motherboard 110_2, and when the second memory unit 153 is switched to the motherboard 110_2, the motherboard 110_2 is allowed to access the second memory unit 153 to execute the power up program of the second BIOS.

For more clearly illustrating the steps of the foregoing operation method of the computer system, a further embodiment is going to be given herebelow in more details. FIG. 5 is a flow chart illustrating a method for operating a blade server according to another embodiment of the present invention. Referring to FIG. 5, at step S502, a power up signal is provided. The power up signal for example can be generated by pressing a switch device equipped to the motherboards. Then, at step S504, it is determined whether to generate a power starting instruction signal according to the power up signal and a busy status of the memory unit, or the power up signal and a busy status of the second memory. For example, when the power up signal and the busy status of the memory unit are both indicated as logic 1, or the power up signal and the busy status of the second memory unit are both indicated as logic 1, the power starting instruction signal is generated, in which the busy status of the memory unit with a logic 1 represents that there is no motherboard presently accessing the memory unit, and the busy status of the second memory unit with a logic 1 represents that there is no motherboard presently accessing the second memory unit.

At step S506, the busy status of the memory unit or the busy status of the second memory unit is adjusted according to the power starting instruction signal for indicating that there is one of the motherboards accessing the memory unit or the second memory unit, and generating a control signal. For example, when the power up starting instruction signal is generated, the busy status of the memory unit is correspondingly changed from logic 1 to logic 0, which indicates that there is one of the motherboards presently accessing the memory unit, and generating a control signal to switch the memory unit to the corresponding motherboard. Or otherwise, while the memory unit runs abnormally, and when the power up starting instruction signal is generated, the busy status of the second memory unit is correspondingly changed from logic 1 to logic 0, which indicates that there is one of the motherboards presently accessing the second memory unit, and generating a control signal to switch the second memory unit to the corresponding motherboard.

At step S508, the memory unit or the second memory unit is switched to one of the motherboards according to the control signal, so as to allow the one of the motherboards to access the memory unit or the second memory unit, and thus executing the power up program of the BIOS stored in the memory unit, or the power up program of the second BIOS stored in the second memory unit. For example, when receiving the control signal, the blade server will switch the memory unit or the second memory unit to a desired motherboard, so as to allow the motherboard to access the memory unit or the second memory unit, and execute the power up program of the BIOS, or the power up program of the second BIOS.

Finally, at step S510, a reset signal is generated to adjust the busy status of the memory unit or the busy status of the second memory unit for indicating that there is no motherboard presently accessing the memory unit or the second memory unit. For example, when the motherboard power up operation is completed, the motherboard will generate a reset signal to change the busy status of the memory unit from logic 0 to logic 1 for indicating that there is no motherboard presently accessing the memory unit so as to allow other motherboards to access the memory unit and execute the power up operation. Or otherwise, while the memory unit runs abnormally, when the motherboard power up operation is completed, the motherboard will generate a reset signal, to change the busy status of the second memory unit from logic 0 to logic 1, for indicating that there is no motherboard presently accessing the second memory unit, so as to allow other motherboards to access the memory unit and execute the power up operation.

Furthermore, the present invention is not restricted to be applied in a blade server, and it can also be applied to a computer having a multiple of CPUs. Further, the memory unit 151, the switch unit 152, and the second memory unit 153 are preferred but not restricted to be disposed on the backplane 150. An embodiment of another configuration is to be illustrated below.

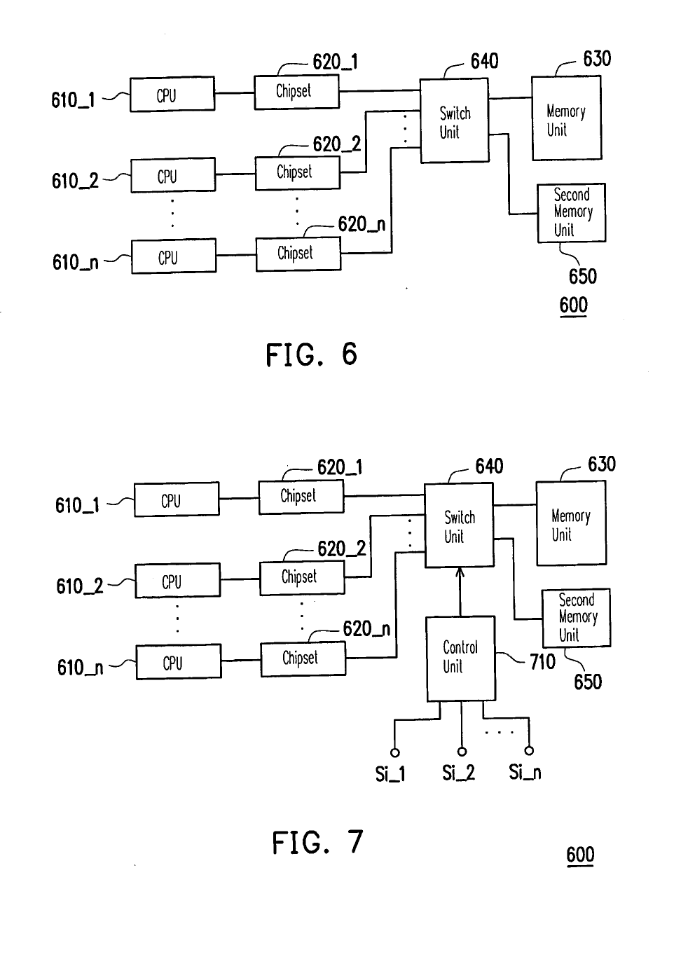

FIG. 6 is a block diagram illustrating a computer according to an embodiment of the present invention. Referring to FIG. 6, a computer 600 includes CPU units 610_1 through 610_{—}n, chipsets 620_1 through 620_{—}n, a memory unit 630, and a switch unit 640, in which n is a positive integer greater than 0, while the range of n is not restricted by the present invention. The chipsets 620_1 through 620_{—}n are respectively and correspondingly coupled to the CPU units 610_1 through 610_{—}n. The memory unit 630 is adapted for storing a BIOS. The switch unit 640 is coupled between the chipsets 620_1 through 620_{—}n and the memory unit 630 for selecting one of the chipsets 620_1 through 620_{—}n according to a control signal, and providing an electric path to allow the selected one of the chipsets 620_1 through 620_{—}n to access the BIOS of the memory unit 630.

Further, the computer 600 further includes a second memory unit 650. The second memory unit 650 is coupled to the switch unit 640, and stores a second BIOS therein. When the memory unit runs abnormally, the switch unit 640 selects one of the chipsets 620_1 through 620_{—}n according to a control signal, and provides a second electric path for allowing the selected one of the chipsets 620_1 through 620_{—}n to access the second BIOS of the second memory unit 650. In the current embodiment, the memory unit 630 and the second memory unit 650 for example are non-volatile memories. The operation of the embodiment is similar as described with FIG. 1, and is not to be iterated hereby.

FIG. 7 illustrates an embodiment of the computer of FIG. 6. Referring to FIG. 7, the computer 600 further includes a control unit 710, and switches 720_1 through 720_{—}n. The control unit 710 is coupled to the switch unit 640 for generating a corresponding control signal according to power up signals Si_1 through Si_{—}n and a busy status of the memory unit 630, or the power up signals Si_1 through Si_{—}n and a busy status of the second memory unit 650. Further, the operation of the embodiment of FIG. 7 can be learnt by referring to the description of FIG. 2, and is not to be iterated hereby.

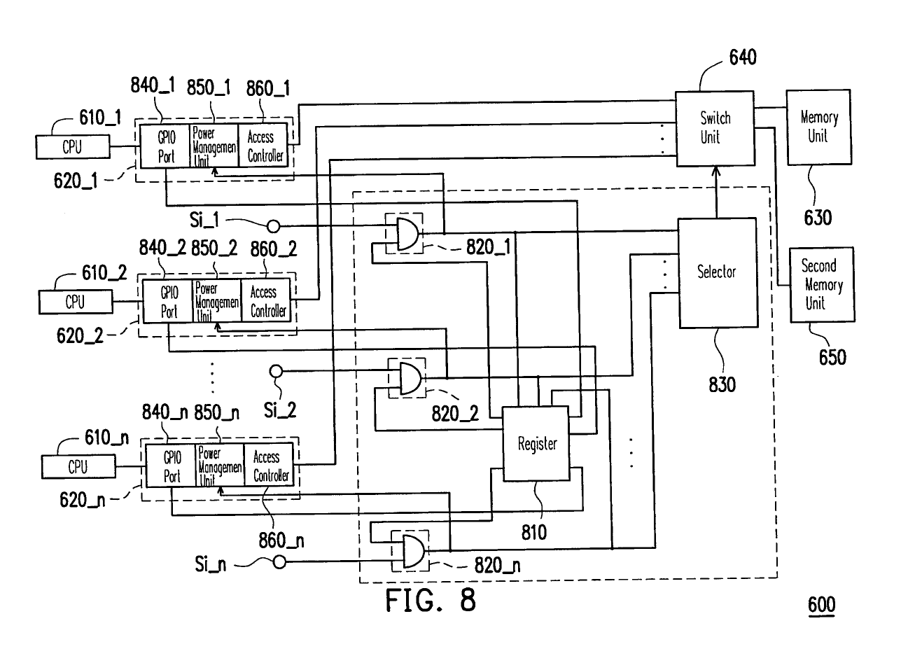

FIG. 8 illustrates the computer of FIG. 7 in details. Referring to FIG. 8, the control unit 710 includes a register 810, logic units 820_1 through 820_{—}n, and a selector 830. The register 810 is adapted for recording the busy status of the memory unit 630, or the busy status of the second memory unit 650, in which the busy status of the memory unit 630 varies according to a reset signal and a power starting instruction signal, so as to indicate whether there is one of the chipsets 620_1 through 620_{—}n presently accessing the memory unit 630. Further, the busy status of the second memory unit 650 varies according to a reset signal and a power starting instruction signal, so as to indicate whether there is one of the chipsets 620_1 through 620_{—}n presently accessing the second memory unit 650.

Each of the logic units 820_1 through 820_{—}n is adapted to generate a power starting instruction signal according to the power up signals Si_1 through Si_{—}n and the busy status of the memory unit 630, or the power up signals Si_1 through Si_{—}n and the busy status of the second memory unit 650. Each of the logic units 820_1 through 820_{—}n includes an AND gate. The AND gate has a first input terminal, a second terminal, and an output terminal. The first input terminal is adapted for receiving the power up signals. The second terminal is adapted to receive the busy status of the memory unit 630, or the busy status of the second memory unit 650. The power starting instruction signal is generated at the output terminal of the AND gate. The selector 830 is adapted to generate the control signal, according to the power starting instruction signal for controlling the switch unit 640 to switch the memory unit 630 or the second memory unit 650 to a corresponding one of the chipsets 620_1 through 620_{—}n.

Each of the chipsets 620_1 through 620_{—}n includes a GPIO port 840_1 through 840_{—}n, a power management unit 850_1 through 850_{—}n, and an access controller 860_1 through 860_{—}n. The GPIO ports 840_1 through 840_{—}n are provided for generating the reset signal. The power management units 850_1 through 850_{—}n are provided for determining whether to start the chipsets 620_1 through 620_{—}n according to the power starting instruction signal. The access controllers 860_1 through 860_{—}n are coupled to the switch unit 640, for accessing the memory unit 630 or the second memory unit 650. Further, the operation of FIG. 8 is similar to that of FIG. 3, and is not to be iterated hereby.

In summary, the present invention allows the motherboards or CPUs or chipsets to share a BIOS of a memory unit by switching. In such a way, the present invention is adapted for not only saving circuit cost, but also improving the refreshing efficiency of the BIOS. Further, the present invention equips with a second memory unit in addition to the memory unit, and stores a second BIOS in the second memory unit, so that when the memory unit runs abnormally, the motherboards, the CPUs, or the chipsets can execute the power up operation with the second memory unit.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A blade server, comprising:
at least one motherboard, and
a backplane, coupled to the at least one motherboard, the backplane comprising:
a memory unit, for storing a basic input output system (BIOS); and
a switch unit, coupled between the at least one motherboard and the memory unit, for coupling the memory unit to one of the at least one motherboard.

2. The blade server according to claim 1, wherein the backplane further comprises:
a second memory unit, coupled to the switch unit, for storing a second BIOS, wherein when the memory unit runs abnormally, the switch unit couples the second memory unit to one of the at least one motherboard.

3. The blade server according to claim 2, wherein the second memory unit is a non-volatile memory.

4. The blade server according to claim 2, wherein the backplane further comprises:
a control unit, coupled to and controlling the switch unit, for generating a control signal according to whether there is a power up signal generated by the at least one motherboard, and a busy status of the memory unit or a busy status of the second memory unit, so as to select one of the at least one motherboard to access the memory unit or the second memory unit via the switch unit.

5. The blade server according to claim 3, wherein each of the at least one motherboard comprises:
a central processing unit (CPU),
a north bridge chip, coupled to the CPU;
a south bridge chip, coupled to the north bridge chip, and comprising:
a general purpose input/output (GPIO) port, for generating a reset signal;
a power management unit, for determining whether to execute a power up operation according to a power starting instruction signal; and
an access controller, coupled to the switch unit, for accessing the memory unit or the second memory unit; and
a switch, adapted for generating the power up signal according to a conduction status thereof.

6. The blade server according to claim 5, wherein the control unit comprises:
a register, for recording a busy status of the memory unit or a busy status of the second memory unit, wherein the busy status of the memory unit or the busy status of the second memory unit varies according to the reset signal and the power starting instruction signal, for indicating whether there is one of the at least one motherboard presently accessing the memory unit or the second memory unit;
at least one logic unit, determining whether to generate the power starting instruction signal according to the power up signal and the busy status of the memory unit or the power up signal and the busy status of the second memory unit; and
a selector, for generating the control signal according to the power starting instruction signal, so as to control the switch unit to switch the memory unit or the second memory unit to a corresponding one of the at least one motherboard.

7. The blade server according to claim 6, wherein each of the at least one logic unit comprises:
an AND gate, having:
a first input terminal, for receiving the power up signal;
a second terminal, for receiving the busy status of the memory unit or the busy status of the second memory unit; and
an output terminal, at which the power starting instruction signal is generated.

8. The blade server according to claim 1, wherein the memory unit is a non-volatile memory.

9. An operation method of a blade server, the blade server comprising at least one motherboard coupling to a memory unit or a second memory unit via a switch unit, the operation method comprising:
providing a control signal; and
selecting one of the at least one motherboard to couple to the memory unit or the second memory unit via the switch unit according to the control signal, so as to allow the selected one of the at least one motherboard to access a basic input output system (BIOS) of the memory unit or a second BIOS of the second memory unit to execute a power up program of the BIOS of the memory unit or the second BIOS of the second memory unit.

10. The operation method according to claim 9, wherein the step of providing the control signal comprises:
providing a power up signal;
determining whether to generate a power starting instruction signal according to the power up signal and a busy status of the memory unit, or the power up signal and a busy status of the second memory unit; and
adjusting the busy status of the memory unit or the busy status of the second memory unit according to the power starting instruction signal to indicate that there is one of the at least one motherboard presently accessing the memory unit or the second memory unit, and generating the control signal.

11. The operation method according to claim 10, further comprising:
generating a reset signal for adjusting the busy status of the memory unit or the busy status of the second memory unit, and indicating that there is no motherboard presently accessing the memory unit or the second memory unit.

12. A computer, comprising:
a plurality of central processing units (CPUs);
a plurality of chipsets, each of which being coupled to one of the CPUs;
a memory unit, for storing a basic input output system (BIOS); and
a switch unit, coupled between the chipsets and the memory unit, for selecting one of the chipsets according to a control signal, and providing an electric path to allow the selected chipset to access the BIOS of the memory unit.

13. The computer according to claim 12, further comprising:
a second memory unit, coupled to the switch unit, for storing a second BIOS, wherein when the memory unit runs abnormally, the switch unit selects one of the chipsets according to the control signal, and provides a second electric path to allow the selected chipset to access the second BIOS of the second memory unit.

14. The computer according to claim 13, wherein the second memory is a non-volatile memory.

15. The computer according to claim 13, further comprising:
a control unit, coupled to the switch unit, for generating the control signal according to a power up signal and a busy status of the memory unit or a busy status of the second memory unit.

16. The computer according to claim 15, wherein the control unit comprises:
a register, adapted for recording a busy status of the memory unit or a busy status of the second memory unit, wherein the busy status of the memory unit or the busy status of the second memory unit varies according to a reset signal and a power starting instruction signal for indicating whether there is one of the chipsets accessing the memory unit or the second memory unit;
a plurality of logic units, each logic unit correspondingly generating the power starting instruction signal according to the power up signal and the busy status of the memory unit or the power up signal and the busy status of the second memory unit; and
a selector, adapted for generating the control signal according to the power starting instruction signal, for controlling the switch unit to switch the memory unit or the second memory unit to a corresponding one of the chipsets.

17. The computer according to claim 16, wherein each of the logic units comprises:
an AND gate, having:
a first input terminal, for receiving the power up signal;
a second terminal, for receiving the busy status of the memory unit or the busy status of the second memory unit; and
an output terminal, at which the power starting instruction signal is generated.

18. The computer according to claim 17, wherein each of the chipsets comprises:
a general purpose input/output (GPIO) port, for generating the reset signal;
a power management unit, for determining whether to start the chipset according to the power starting instruction signal; and
an access controller, coupled to the switch unit, for accessing the memory unit or the second memory unit.

19. The computer according to claim 12, wherein the memory unit is a non-volatile memory.
